(19) United States
(12) Patent Application Publication
(10) Pub. No.: US 2026/0312939 A1
(43) Pub. Date: Oct. 8, 2026

(54) SUBSCRIBER AUTHENTICATION IN A NON-PUBLIC NETWORK

(71) Applicant: Verizon Patent and Licensing Inc., Basking Ridge, NJ (US)

(72) Inventors: Chien-Yuan Huang, Basking Ridge, NJ (US); David Albert Rossetti, Randolph, NJ (US); Toby Varughese John, Murphy, TX (US)

(21) Appl. No.: 19/173,069

(22) Filed: Apr. 8, 2025

(51) Int. Cl. H04L 9/40; H04W 12/0431; H04W 84/04; H04W 84/12

(52) U.S. Cl. CPC H04L 63/029; H04W 12/0431; H04W 84/042; H04W 84/12

(57) ABSTRACT

A Public Land Mobile Network (PLMN) includes an Evolved Packet Data Gateway (ePDG) and a Non-Seamless Wireless Local Area Network (WLAN) Offload Function (NSWOF). The ePDG receives control plane (CP) and user plane (UP) traffic sent from a User Equipment device (UE) over a Non-Public Network (NPN). The NSWOF receives the CP traffic from the ePDG, translates the CP traffic to a Service-Based Interface (SBI) format of a Service-Based Architecture (SBA) of the PLMN, and sends the translated CP traffic to at least one Network Function (NF) in the PLMN for accessing a PLMN service provided by the at least one NF.

### BACKGROUND

Non-Public Networks (NPNs) are networks that are intended for non-public, or private, use by certain authorized users. NPNs typically connect to an external public network, such as the Internet and/or a Public Land Mobile Network (PLMN). A mobile NPN provides mobile services for a defined set of users or “things” that are usually part of a single organization. NPNs may be classified as either Public Network Integrated NPN (PNI-NPN) or Standalone NPN (SNPN). A PNI-NPN is deployed with the support of a PLMN. For example, a PNI-NPN may be deployed as a private network slice of the PLMN used solely by the PNI-NPN owner, or the PNI-NPN may use a portion of the functions or components of the PLMN but further include private network elements at a customer location. The private part of a PNI-NPN can be isolated from external networks, including the PLMN, and may reside behind firewalls or other security infrastructure. An SNPN does not rely on network functions provided by a PLMN. An SNPN may, in some circumstances, use locally licensed spectrum that may be allocated on a localized basis to support the needs of a business organization or other entity. Alternatively, an SNPN can use components of a cellular Radio Access Network (RAN) in unlicensed spectrum. For example, the 6 GHz spectrum band in the U.S. is an example of an unlicensed band that could be used in a cellular RAN of an SNPN.

### BRIEF DESCRIPTION OF THE DRAWINGS

FIG. 1 depicts an example network environment in which a user equipment device (UE) may connect to an SNPN and access PLMN services in an external PLMN via the SNPN, or may connect to a PLMN and access SNPN services via the PLMN;

FIG. 2A illustrates a high-level example of a UE obtaining NPN-to-PLMN access to one or more PLMN services in a PLMN via the NPN;

FIG. 2B illustrates a high-level example of a UE obtaining PLMN-to-NPN access to one or more NPN services in an NPN via the PLMN;

FIG. 3 depicts example components of a PLMN or an NPN that may be involved in providing access to PLMN services via the NPN, or access to NPN services via the PLMN;

FIG. 4 illustrates UE access to PLMN services via an SNPN using an Evolved Packet Data Gateway (ePDG) and a Non-Seamless Wireless Local Area Network (WLAN) Offload Function (NSWOF) implemented within the PLMN;

FIG. 5 illustrates UE access to SNPN services via a PLMN using an ePDG and a NSWOF implemented within the SNPN;

FIG. 6 is a diagram that depicts example components of a network device, as referred to herein;

FIG. 7 is a flow diagram of an example process for authenticating, by an ePDG within a PLMN, a UE connected to an NPN for establishing a secure tunnel, for the UE’s traffic, from the NPN to the PLMN, or for authenticating, by the ePDG within the NPN, a UE connected to the PLMN for establishing a secure tunnel, for the UE’s traffic, from the PLMN to the NPN; and

FIGS. 8A and 8B illustrate examples of operations, messages, and data flows associated with a process described herein.

### DETAILED DESCRIPTION

The following detailed description refers to the accompanying drawings. The same reference numbers in different drawings may identify the same or similar elements. The following detailed description does not limit the invention.

Example embodiments described herein facilitate the interworking of an SNPN with an external PLMN by enabling UEs connected to the SNPN to access Network Function (NF) services provided by the PLMN, or by enabling UEs connected to the PLMN to access NF services provided by the SNPN. The SNPN may connect directly to the external PLMN, or via an intervening data network (e.g., the Internet). To enable UE access to NF services in the PLMN via the SNPN, embodiments described herein implement an Evolved Packet Data Gateway (ePDG) and a Non-Seamless Wireless Local Area Network (WLAN) Offload Function (NSWOF) within the PLMN. Further embodiments may additionally, or alternatively, implement an ePDG and NSWOF within the SNPN to enable UE access to NF services in the SNPN via the PLMN. The ePDG and NSWOF combination may further enable establishment of a secure tunnel for a data session(s) across the SNPN to the ePDG in the PLMN, or across the PLMN to the ePDG in the SNPN.

To establish the secure tunnel from a UE across the SNPN, the ePDG and NSWOF facilitate authentication of the UE by NFs located within the PLMN. As further described herein, the NSWOF acts as a converter/translator for translating different message formats to a message format compatible with a Service-Based Interface (SBI) of the Service-Based Architecture (SBA) of the PLMN or SNPN. The NSWOF, therefore, translates Control Plane (CP) messages (e.g., Diameter-based CP messages based on Request for Comments (RFC) 3588 and its enhancements) received from ePDG in one or more different messages formats to a message format compatible with the SBI, and translates responsive CP messages received from PLMN/SNPN NFs in the SBI compatible message format to the one or more different message formats. The SBI message format may be compatible with web-based protocols such as, for example, Hypertext Transfer Protocol (HTTP) (e.g., HTTP/2). As another example, the SBI message format may be compatible with JavaScript Object Notation (JSON).

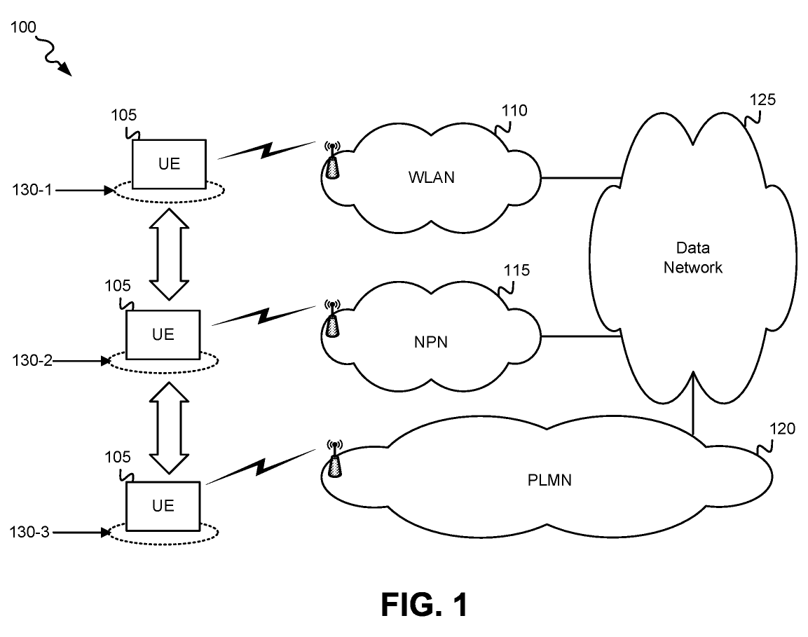

FIG. 1 depicts an example network environment 100 in which a user equipment device (UE) may connect to an SNPN and access PLMN services in an external PLMN via the SNPN, or may connect to a PLMN and access SNPN services via the PLMN. As shown, network environment 100 may include a UE 105, a wireless local area network (WLAN) 110, an NPN 115, a PLMN 120, and a data network 125.

UE 105 may include any type of electronic device having a wireless communication capability. Though only a single UE 105 is shown residing at different locations/areas 130, network environment 100 may include any number of UEs 105 (e.g., >>1). UE 105 may each include, for example, a laptop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (not shown) may carry, use, administer, and/or operate UE 105. UE 105 may execute at least one client app (not shown) that may engage in one or more data sessions via WLAN 110, NPN 115, and/or PLMN 120. UE 105, or the user of UE 105, may maintain a subscription with NPN 115 and/or PLMN 120, or may be designated (i.e., enrolled) as an authorized user of NPN 115 and/or PLMN 120. UE 105 may support the SWu interface per 3GPP 23.402 and, using techniques described herein, UE 105 may not need to support the NWu interface.

WLAN 110 may include, for example, a Wi-Fi network that interconnects with data network 125 and enables UE 105 to engage in data sessions with devices or nodes located in data network 125. Other types of WLANs may, however, be implemented in network environment 100.

NPN 115 may include any type of NPN that enables wireless communication involving UE 105 and which further may interconnect with data network 125 and PLMN 120. Though FIG. 1 shows NPN 115 as connecting indirectly to PLMN 120 via data network 125, in some implementations, NPN 115 may connect directly to PLMN 120.

PLMN 120 may include any type of a PLMN. In some implementations, PLMN 120 may include a Fourth Generation (4G) Long-Term Evolution (LTE) network. In other implementations, PLMN 120 may include any type of a Next Generation mobile network that may include evolved network components (e.g., future generation components) relative to an LTE network, such as a 4G or 4.5G LTE mobile network. For example, PLMN 120 may include a Fifth Generation (5G) mobile network. PLMN 120 may alternatively, or additionally, include another type of Next Generation network (e.g., a 5G Advanced network, a Sixth Generation (6G) mobile network), or a hybrid mobile network (e.g., a Next Generation/4G hybrid network, such as a 4G with 5G Non-Stand-Alone (NSA) hybrid network).

Data network 125 may include one or more interconnected networks, such as, for example, local area networks (LANs), wide area networks (WANs), metropolitan area networks (MANs), telecommunications networks (e.g., Public Switched Telephone Networks (PSTNs)), cable networks (e.g., optical cable networks), Multi-Access Edge Computing networks (MECs), and/or the Internet. In some circumstances, data network 125 may include one or more interconnected public networks.

As illustrated in FIG. 1, UE 105 may move between different geographic locations or areas 130-1, 130-2, or 130-3. At location/area 130-1, UE 105 may be within wireless range of WLAN 110 such that UE 105 may wirelessly connect to WLAN 110. At location/area 130-2, UE 105 may be within wireless range of NPN 115 such that UE 105 may wirelessly connect to NPN 115. At location/area 130-3, UE 105 may be within wireless range of PLMN 120 such that UE 105 may wirelessly connect to PLMN 120. In some circumstances, any one of locations/areas 130-1, 130-2, or 130-2 may be coextensive with any of the other locations or areas. For example, location/area 130-1 may be coextensive with (e.g., overlap) location/area 130-3 such that UE 105 may simultaneously, or alternatively, connect to WLAN 110 and/or PLMN 120. As another example, locations/areas 130-1, 130-2, and 130-3 may coextensive such that UE 105 may simultaneously, or alternatively, connect to WLAN 110, NPN 115, and/or PLMN 120.

The configuration of components/networks of the network environment 100 of FIG. 1 is for illustrative purposes. Other configurations, having a different arrangement than depicted in FIG. 1, may be implemented. Network environment 100 may also include additional, fewer, and/or different components/networks than shown in FIG. 1. For example, network environment 100 may include additional, and/or different, networks than those shown in FIG. 1.

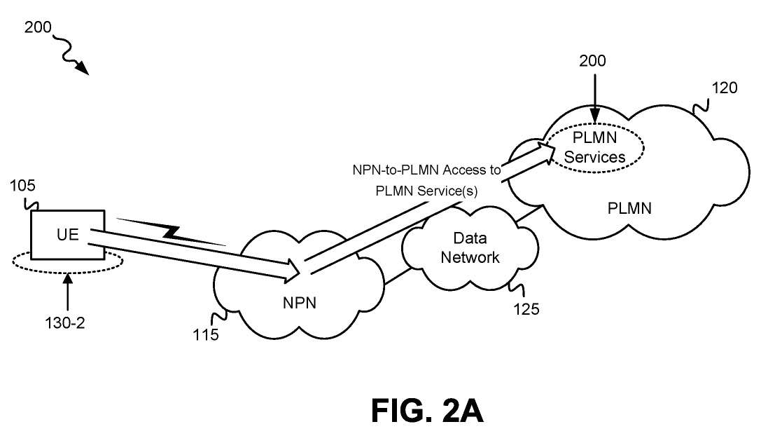

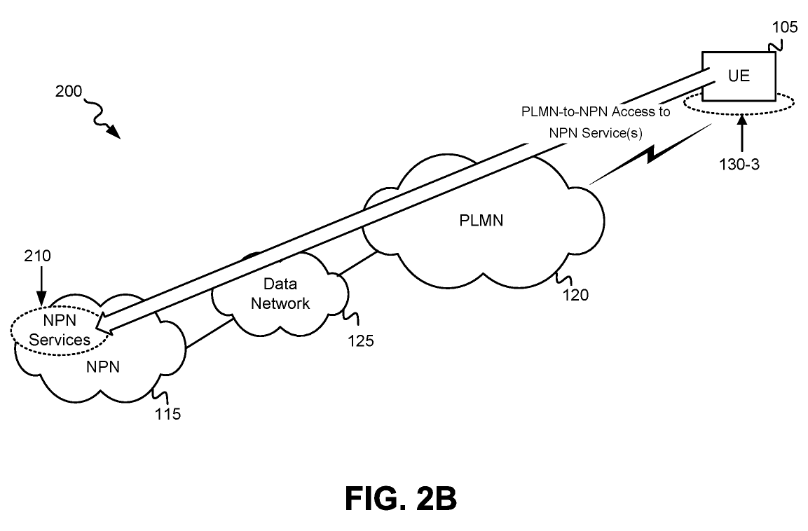

FIG. 2A illustrates a high-level example of a UE 105, residing at location/area 130-2, obtaining NPN-to-PLMN access to one or more PLMN services 200 in PLMN 120 via NPN 115. As shown, data network 125 interconnects NPN 115 and PLMN 120, and UE 105 may wirelessly connect to NPN 115 when located at location/area 130-2. Once UE 105 wirelessly connects to NPN 115, UE 105 may access, as described further below, the one or more PLMN services 200 provided by PLMN 120 via NPN 115 and data network 125. The one or more PLMN services 200 may include, for example, authentication services. Other types of PLMN services provided by NFs of PLMN 120 may be accessed from NPN 115. In the example of FIG. 2A, UE 105, or the user (not shown) of UE 105, may have a subscription to, or be an authorized user of, PLMN 120, enabling UE 105 to use PLMN services 200 from UE 105’s location 130-2 in NPN 115.

FIG. 2B illustrates a high-level example of a UE 105, residing at location/area 130-3, obtaining PLMN-to-NPN access to one or more NPN services 210 in NPN 115 via PLMN 120. As shown, UE 105 may wirelessly connect to PLMN 120 when located at location/area 130-3. Once UE 105 wirelessly connects to PLMN 120, UE 105 may access, as described further herein, the one or more NPN services 210 provided by NPN 115 via PLMN 120 and interconnecting data network 125. . In the example of FIG. 2B, UE 105, or the user (not shown) of UE 105, may have a subscription to, or be an authorized user of, NPN 115, enabling UE 105 to use NPN services 210 from UE 105’s location 130-3 in PLMN 120.

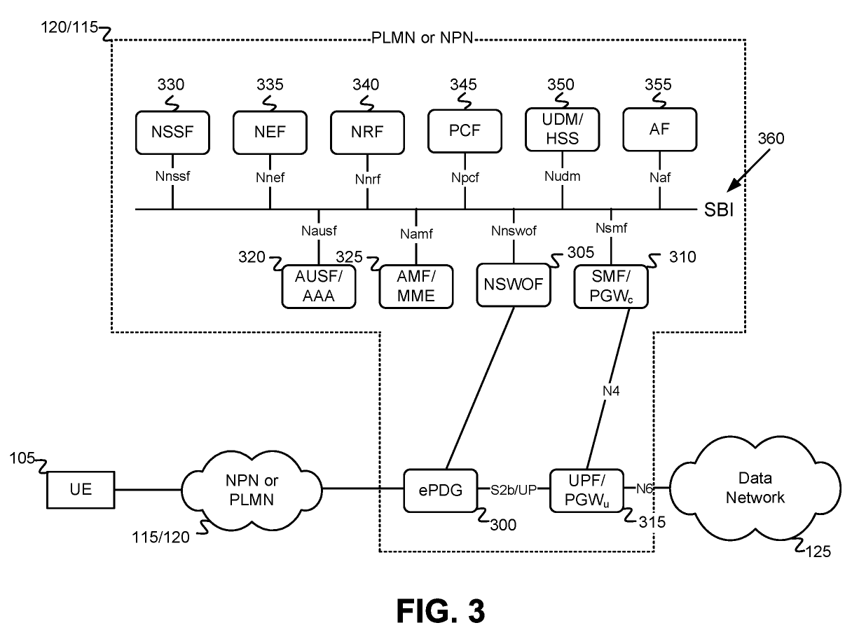

FIG. 3 depicts example components of either PLMN 120 or NPN 115 that may be involved in providing access to PLMN services via NPN 115, or access to NPN services via PLMN 120. In one implementation, UE 105 may wirelessly connect to NPN 115 and NPN 115 may interconnect with PLMN 120 via an evolved Packet Data Gateway (ePDG) 300 within PLMN 120. In this implementation, the various components shown within the enclosed area defined by the dashed line in FIG. 3 may be components of PLMN 120. In another implementation, UE 105 may wirelessly connect to PLMN 120, and PLMN 120 may interconnect with NPN 115 via an ePDG 300 within NPN 115. In this implementation, the various components shown within the enclosed area defined by the dashed line in FIG. 3 may be components of NPN 115.

NPN 115 or PLMN 120 may include various network functions (NFs), as depicted within the area defined by the dashed line in FIG. 3. The various NFs may include, for example, a Non-Seamless WLAN Offload Function (NSWOF) 305, a Session Management Function (SMF) 310, a User Plane Function (UPF) 315, an Authentication Server Function (AUSF) 320, an Access and Mobility Management Function (AMF) 325, a Network Slice Selection Function (NSSF) 330, a Network Exposure Function (NEF) 335, a Network Repository Function (NRF) 340, a Policy Control Function (PCF) 345, a Unified Data Management (UDM) function 350, and an Application Function (AF) 355.

In an implementation where the area enclosed within the dashed line of FIG. 3 is PLMN 120, PLMN 120 may be a 5G network, a 4G network, or a hybrid 4G/5G NSA network. If PLMN 120 includes a 4G network or hybrid 4G/5G NSA network, then NFs SMF 310, UPF 315, AUSF 320, AMF 325, and UDM 350 may be replaced, respectively, by a Packet Gateway-Control Plane (PGW_{C}) 310, a PGW-User Plane (PGW_{U}) 315, an AAA server (AAA) 320, a Mobility Management Entity (MME) 325, and a Home Subscriber Server (HSS) 350.

NPN 115 and PLMN 120 may each employ a Service-Based Architecture (SBA) that allows each network’s NFs to interface with one another through defined interfaces. The SBA employed by NPN 115 and/or PLMN 120 implements a Service-Based Interface (SBI) 360 to enable communication between NFs. In some implementations, the SBI 360 uses web-based protocols, such as Hypertext Transfer Protocol/2 (HTTP/2) and RESTful Application Programming Interfaces (APIs) to enable NF communication and interaction. In other implementations, the SBI 360 may use JSON.

NSWOF 305 may, in some implementations, interface to WLAN 110 and AUSF 320 to support UE 105’s WLAN connections using NPN 115/PLMN 120 credentials. NSWOF 305 may additionally interface with ePDG 300 and receive messages related to either accessing NF services of NFs in PLMN 120 via NPN 115, or accessing NF services of NFs in NPN 115 via PLMN 120. The messages received by NSWOF 305 from ePDG 300 may be in various different formats and NSWOF 305 may convert/translate those various different formats into a format (e.g., HTTP/2, JSON) that conforms to that used in the SBI 360 of the SBA of NPN 115 or PLMN 120. In one implementation, the messages received by NSWOF 305 from ePDG 300 may include Diameter-based CP messages based on RFC 3588 and its enhancements and ePDG 300 may convert the Diameter-based CP messages into the SBI 360’s HTTP/2 or JSON format. NSWOF 305 may, therefore, act as a converter/translator of different message formats between ePDG 300 and the SBI 360 of NPN 115/PLMN 120.

SMF 310 performs session management and selects and controls UPFs 315 for data transfer. In a 4G or hybrid 4G/5G NSA network, a PGW_{C} may replace SMF 310 and perform at least some of SMF 310’s functions. UPF 315 may act as a router and a gateway between PLMN 120/NPN 115 and data network 125 and may forward session data between data network 125 and ePDG 300. Though only a single UPF 315 is shown in FIG. 2, PLMN 120/NPN 115 may include multiple UPFs 315 at various locations in PLMN 120/NPN 115. In a 4G or hybrid 4G/5G NSA network, a PGW_{U} may replace UPF 315 and perform at least some of the functions performed by UPF 315.

AUSF 320 may implement authentication and security key management functions for authorizing UE access to NPN 115/PLMN 120 and for establishing secure connections. AUSF 320 further interacts with AMF 325 to manage subscriber mobility and handover procedures, to support session management, and to interact with UDM 350 to manage subscriber data and profiles. In a 4G or hybrid 4G/5G NSA network, an AAA server may replace AUSF 320 and perform at least some of AUSF 320’s functions.

AMF 325 performs mobility management for UE 105. In a 4G or hybrid 4G/5G NSA network, an MME may replace AMF 325 and perform at least some of AMF 325’s mobility management functions. NSSF 330 may obtain Network Slice Instance (NSI) and network slicing configuration information from a Slice Orchestration System (not shown) within NPN 115/PLMN 120 and may select a set of network slice instances that may serve a UE session and may determine an allowed single Network Slice Selection Assistance Information (S-NSSAI) for the UE session.

NRF 340 operates as a centralized repository of information regarding NFs in NPN 115 or PLMN 120. NRF 340 enables NFs (e.g., UPF 315, SMF 310, AMF 325, PCF 345, UDM 350, NEF 335) to register and discover each other via an Application Programming Interface (API). NRF 340 maintains an updated repository of information about the NFs available in NPN 115 or PLMN 120, along with information about the services provided by each of the NFs. NRF 340 further enables the NFs to obtain updated status information of other NFs in NPN 115 or PLMN 120. NRF 340 may, for example, maintain profiles of available NF instances and their supported services, allow NF instances to discover other NF instances in NPN 115 or PLMN 120, and allow NF instances to track the status of other NF instances.

PCF 345 may provide policy rules for control plane functions (e.g., for network slicing, roaming, and/or mobility management) and may access user subscription information for policy decisions. UDM 350 manages data for user access authorization, user registration, and data network profiles. UDM 350 may include, or operate in conjunction with, a User Data Repository (UDR - not shown) which stores user data, such as user/customer/subscriber profile information, user/customer/subscriber authentication information, user/customer-subscribed network slice information, and encryption keys. In a 4G or hybrid 4G/5G NSA network, an HSS may replace UDM 350 and perform at least some of UDM 350’s functions.

AF 355 may provide session related information to PCF 345 in support of policy control rule generation. NEF 335 may expose network capabilities and events provided by NFs to AF 355, and may provide a means for AF 355 to provide information to NPN 115/PLMN 120.

Each of ePDG 300, NSWOF 305, SMF/PGW_{C} 310, UPF/PGW_{U} 315, AUSF/AAA server 320, AMF/MME 325, NSSF 330, NEF 335, NRF 340, PCF 345, UDM/HSS 350, and AF 355 may be implemented as a Virtual Network Function (VNF) or a Cloud-Native Network Function (CNF) (e.g., at a data center(s)) or as a Physical Network Function (PNF) within NPN 115 or PLMN 120.

Though not shown in FIG. 3, PLMN 120 and/or NPN 115 may each include a Radio Access Network (RAN) that enables UE 105 to wirelessly communicate via PLMN 120 or NPN 115. In implementations in which the RAN is a 5G RAN, the RAN’s radio access equipment may include multiple Radio Units (RUs), multiple Distributed Units (DUs), at least one Control Unit–User Plane function (CU-UP) and at least one Control Unit–Control Plane (CU-CP) function. Additionally, or alternatively, the RAN may include non-split or integrated RAN devices, such as Next Generation NodeBs (gNBs) or Evolved NodeBs (eNBs). In some implementations, the RAN of PLMN 120 and/or NPN 115 may be Open RAN (ORAN) compliant and may support ORAN interfaces (e.g., E1, F1) and include a RAN Intelligent Controller.

Though described as having 5G RAN components, the RAN of NPN 115 and/or PLMN 120 may each have other RAN components than those described herein (e.g., 4G RAN components, 6G RAN components). The configuration of network components of the example NPN 115 or PLMN 120 shown in FIG. 3 is for illustrative purposes. Other configurations may be implemented. Therefore, NPN 115 and/or PLMN 120 may include additional, fewer, and/or different components that may be configured in a different arrangement than that depicted in FIG. 3. Though only a single instance of each of the NFs (e.g., UPF 315, SMF 310, AMF 325, NEF 335, PCF 345, UDM 350, AF 355) is shown in FIG. 3, NPN 115 and/or PLMN 120 may include multiple instances of one or more of the NFs. Further, NPN 115 and/or PLMN 120 may include other NFs not shown in FIG. 3. When implemented as VNFs or CNFs, each of the NFs described above may be installed in, and executed by, a network device residing in NPN 115 or PLMN 120, or in another network (e.g., in an edge or a far edge network, not shown). A single network device may host and execute one or more of the NFs described above, and NPN 115 and/or PLMN 120 may include at least one network device, or may have multiple (e.g., numerous) network devices that each host and execute one or more of the NFs described above. PLMN 120 or NPN 115 may include additional, or alternative, NFs and/or network components than those shown in FIG. 3. For example, PLMN 120 or NPN 115 may include NFs or network components associated with a 4G, hybrid 4G/5G, or hybrid 5G/6G mobile network.

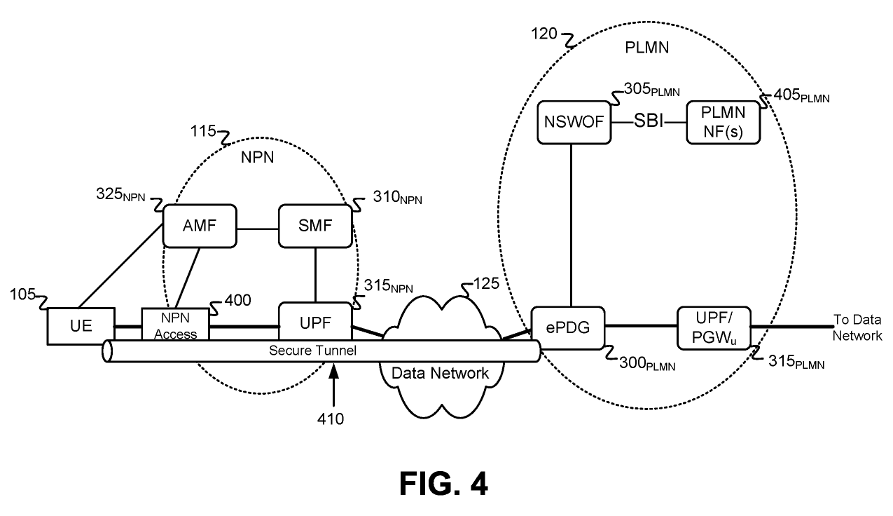

FIG. 4 illustrates UE access to PLMN services via a SNPN 115 using an ePDG 300 and NSWOF 305 implemented within a PLMN 120. UE 105 may first connect, via NPN access 400 (e.g., using the RAN of NPN 115), to NPN 115 to attempt to establish a session. AMF 325_{NPN} and SMF 310_{NPN} of NPN 115 may operate, via the control plane of NPN 115 in accordance with existing protocols, to establish the connection with UE 105. Subsequent to establishing the connection with NPN 115, UE 105 may initiate an authentication process for establishing a session from NPN 115, via data network 125 and ePDG 300_{PLMN}, to PLMN 120. The authentication process may involve UE 105 accessing one or more services of PLMN NFs 405_{PLMN} in PLMN 120 via NPN 115 and ePDG 300_{PLMN} within PLMN 120. UE 105 may access other services provided by PLMN NF(s) 405_{PLMN} within PLMN 120 via NPN 115 and ePDG 300_{PLMN}. Upon successful completion of the authentication process, ePDG 300_{PLMN} and UE 105 may create a secure tunnel 410 for use by UE 105 in engaging in a user plane (UP) Packet Data Unit (PDU) session(s) from NPN 115 across PLMN 120. In some implementations, secure tunnel 410 may be an Internet Protocol Security (IPsec) tunnel.

During access to the PLMN services, ePDG 300_{PLMN} sends incoming control plane (CP) messages, related to a session(s) involving UE 105, to NSWOF 305_{PLMN} so that NSWOF 305_{PLMN} can translate the incoming CP messages from a first message format to a message format that is compatible with the SBI 360 to enable access to PLMN services provided by the one or more PLMN NFs 405_{PLMN}. Further, NSWOF 305_{PLMN} receives outgoing, responsive CP messages, related to the PLMN service access for UE 105, from the one or more PLMN NFs 405_{PLMN} and translates the outgoing CP messages from the message format compatible with the SBI 360 to the first message format for delivery to ePDG 300_{PLMN}. ePDG 300_{PLMN}, in turn, forwards the translated CP message(s) to NPN 115.

Outgoing data for data sessions involving UE 105 may transit from NPN 115 to ePDG 300_{PLMN}, via secure tunnel 410, to UPF/PGWU 315_{PLMN} and then on to a destination in the data network. Incoming data for data sessions involving UE 105 may be received at UPF/PGWU 315_{PLMN} of PLMN 120 from a source in the data network, and then forwarded on to ePDG 300_{PLMN} for transit to UE 105 in NPN 115 via secure tunnel 410.

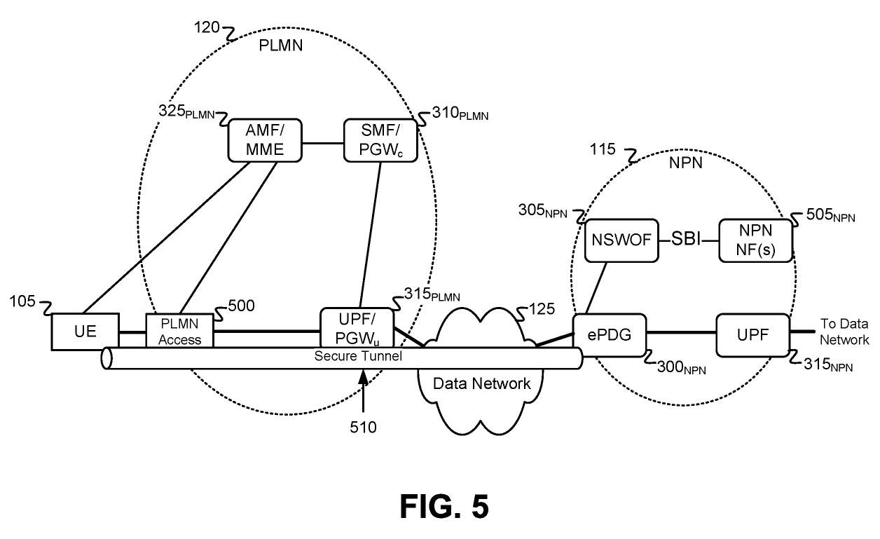

FIG. 5 illustrates UE access to SNPN services via a PLMN 120 using an ePDG 300 and NSWOF 305 implemented within an NPN 115. UE 105 may first connect, via PLMN access 500 (e.g., using the RAN of PLMN 120), to PLMN 120 to attempt to establish a session. AMF 325_{PLMN} and SMF 310_{PLMN} of PLMN 120 may operate, via the CP of PLMN 120 in accordance with existing protocols, to establish the connection with UE 105.

Subsequent to establishing the connection with PLMN 120, UE 105 may initiate an authentication process for establishing a session from PLMN 120, via data network 125 and ePDG 300_{PLMN}, to NPN 115. The authentication process may involve UE 105 accessing one or more services of PLMN NFs 505_{NPN} in NPN 115 via PLMN 120 and ePDG 300_{NPN} within NPN 115. UE 105 may access other services provided by PLMN NF(s) 505_{NPN} within NPN 115 via PLMN 120 and ePDG 300_{NPN}. Upon successful completion of the authentication process, ePDG 300_{NPN} and UE 105 may create a secure tunnel 510 for use by UE 105 in engaging in a UP PDU session(s) from PLMN 120 across NPN 1115. In some implementations, secure tunnel 510 may be an IPsec tunnel.

During access to the NPN services, ePDG 300_{NPN} sends incoming CP messages, related to a session(s) involving UE 105, to NSWOF 305_{NPN} so that NSWOF 305_{NPN} can translate the incoming CP messages from a first message format to a message format that is compatible with the SBI 360 to enable access to NPN services provided by the one or more NPN NFs 505_{NPN}. Further, NSWOF 305_{NPN} receives outgoing CP messages, related to the NPN service access for UE 105, from the one or more NPN NFs 505_{NPN} and translates the outgoing CP messages from the message format compatible with the SBI 360 to the first message format for delivery to ePDG 300_{NPN}. ePDG 300_{NPN}, in turn, forwards the translated CP message(s) to PLMN 120.

Outgoing data for data sessions involving UE 105 may transit from PLMN 120 to ePDG 300_{NPN}, via secure tunnel 510, to UPF/PGW_{U} 315_{NPN} and then on to a destination in the data network 125. Incoming data for data sessions involving UE 105 may be received at UPF/PGW_{U} 315_{NPN} of NPN 115 from a source in the data network 125, and then forwarded on to ePDG 300_{NPN} for transit to UE 105 in PLMN 120 via secure tunnel 510.

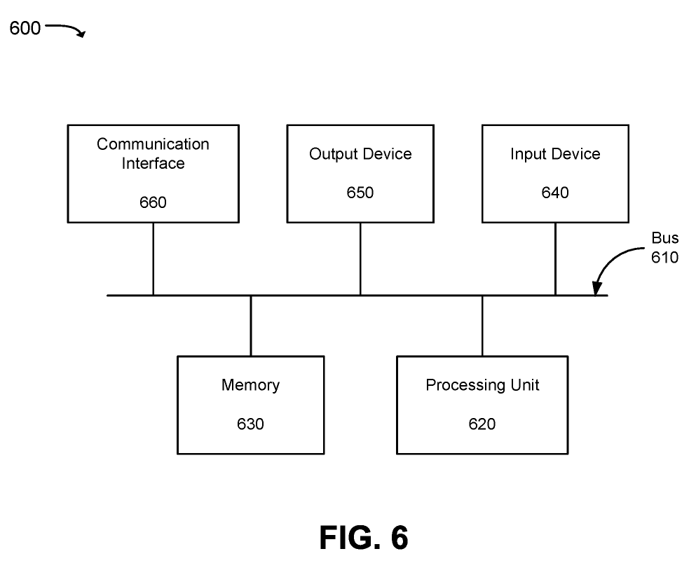

FIG. 6 is a diagram that depicts example components of a network device 600 (referred to herein as a “network device,” or a “device”). UE 105 and ePDG 300 may each include components that are the same as, or similar to, those of device 600 shown in FIG. 6. Furthermore, each of the NFs in NPN 115 and PLMN 120 (e.g., NSWOF 305, SMF/PGW_{C} 310, UPF/PGW_{U} 315, AMF/MME 325, AUSF 320, NSSF 330, NEF 335, NRF 340, PCF 345, UDM/HSS 350, and AF 355) may be implemented by a device that includes components that are the same as, or similar to, those of network device 600. Some of the NFs of NPN 115 may be implemented by a same device 600 within NPN 115, while others of the functions may be implemented by one or more separate devices 600 in NPN 115. Similarly, some of the NFs of PLMN 120 may be implemented by a same device 600 within PLMN 120, while others of the functions may be implemented by one or more separate devices 600 in PLMN 120. Multiple components of NPN 115 and/or PLMN 120 may be referred to herein as a “system” (e.g., ePDG 300 and NSWOF 305 may be considered a “system” in NPN 115 and/or PLMN 120) that may cooperate to perform to one or more functions, services, or operations.

Device 600 may include a bus 610, a processing unit 620, a memory 630, an input device 640, an output device 650, and a communication interface 660. Bus 610 may include a path that permits communication among the components of device 600. Processing unit 620 may include one or more processors or microprocessors which may interpret and execute instructions, or processing logic. Memory 630 may include one or more memory devices for storing data and instructions. Memory 630 may include a random access memory (RAM) or another type of dynamic storage device that may store information and instructions for execution by processing unit 620, a Read Only Memory (ROM) device or another type of static storage device that may store static information and instructions for use by processing unit 620, and/or a magnetic, optical, or flash memory recording and storage medium. The memory devices of memory 630 may each be referred to herein as a "tangible non-transitory computer-readable medium,” “non-transitory computer-readable medium,” or “non-transitory storage medium.” In some implementations, the processes/methods set forth herein can be implemented as instructions that are stored in memory 630 for execution by processing unit 620.

Input device 640 may include one or more mechanisms that permit an operator to input information into device 600, such as, for example, a keypad or a keyboard, a display with a touch sensitive panel, voice recognition and/or biometric mechanisms, etc. Output device 650 may include one or more mechanisms that output information to the operator, including a display, a speaker, etc. Input device 640 and output device 650 may, in some implementations, be implemented as a user interface (UI) that displays UI information and which receives user input via the UI. Communication interface 660 may include a transceiver(s) that enables device 600 to communicate with other devices and/or systems. For example, communication interface 660 may include one or more wireless transceivers (e.g., RF transceivers) for communicating via a RAN of NPN 115 or PLMN 120. In some implementations, communication interface 660 may additionally include one or more wired transceivers for communicating via data network 125 (e.g., the Internet) or via a wired portion of NPN 115 or PLMN 120.

The configuration of components of network device 600 illustrated in FIG. 6 is for illustrative purposes. Other configurations may be implemented. Therefore, network device 600 may include additional, fewer and/or different components, that may be arranged in a different configuration, than depicted in FIG. 6.

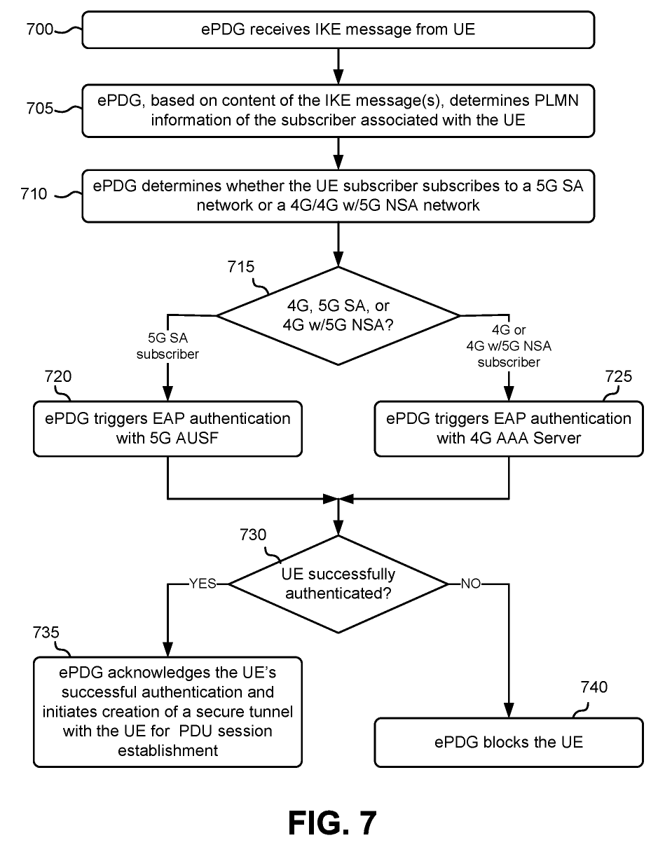

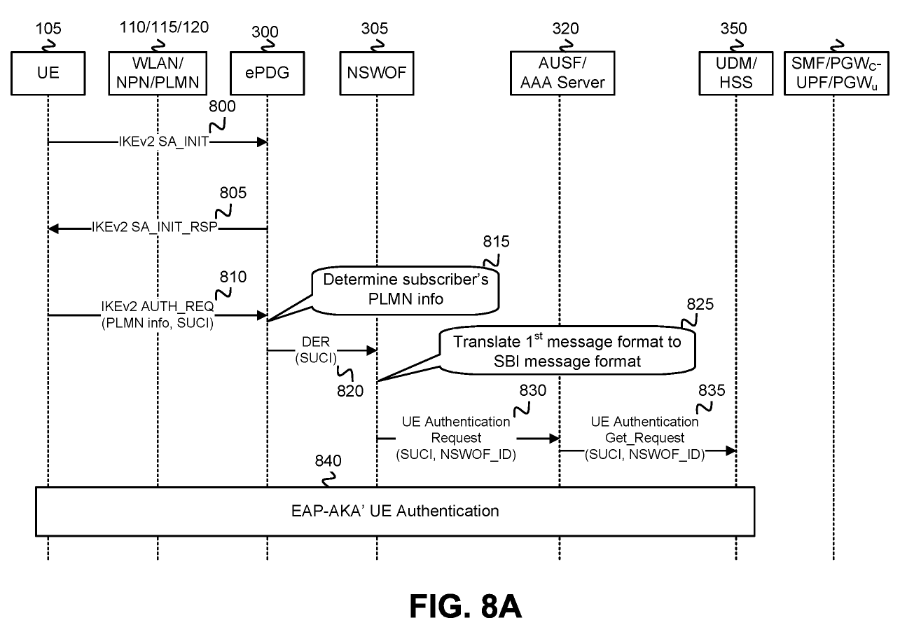

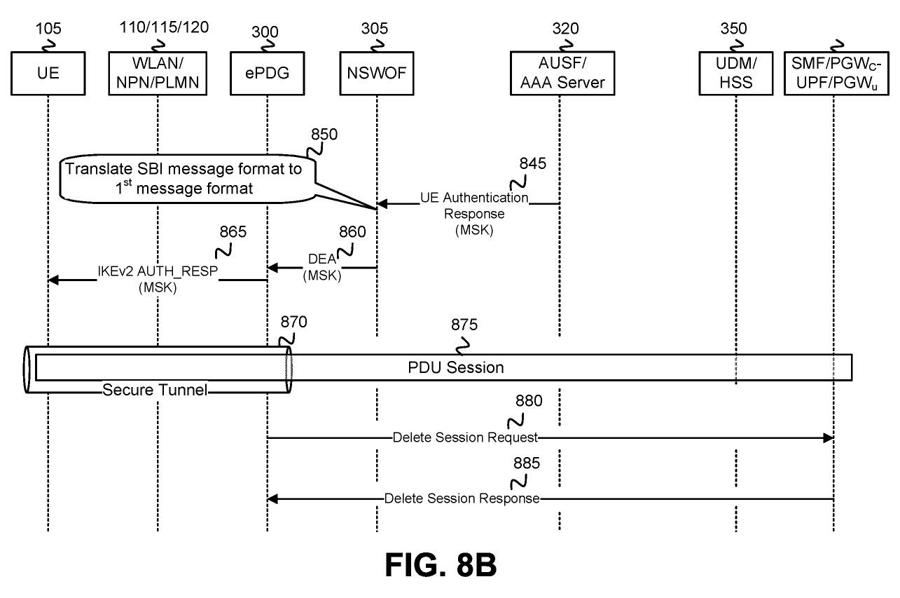

FIG. 7 is a flow diagram of an example process for authenticating, by an ePDG 300 within PLMN 120, a UE 105 connected to NPN 115 for establishing a secure tunnel, for the UE 105’s traffic, from NPN 115 to PLMN 120, or for authenticating, by an ePDG 300 within NPN 115, a UE 105 connected to PLMN 120 for establishing a secure tunnel, for the UE 105’s traffic, from PLMN 120 to NPN 115. The example process of FIG. 7 may be implemented by an ePDG 300 within either PLMN 120 or NPN 115, in cooperation with a NSWOF 305, and using other NFs of PLMN 120 and/or NPN 115 (e.g., AUSF/AAA server 320, a UDM/HSS 350, SMF 310/UPF 315 (or PWG_{C}/PGW_{U} 310/315)). The example process is described below with additional reference to the diagrams of FIGS. 8A and 8B.

The example process includes ePDG 300 receiving an Internet Key Exchange (IKE) message from UE 105 (block 700). The IKE message may, for example, include an IKE version 2 (IKEv2) message (e.g., an IKEv2 SA-Init message) that begins a process of authenticating UE 105 and establishing a secure connection between UE 105 and ePDG 300. If UE 105 is connected to NPN 115, ePDG 300 may reside in PLMN 120, as shown in FIG. 4. Conversely, if UE 105 is connected to PLMN 120, ePDG 300 may reside in NPN 115, as shown in FIG. 5. FIG. 8A illustrates UE 105 sending an IKEv2 SA-INIT message 800, across WLAN 110 and NPN 115/PLMN 120, to an ePDG 300.

As shown, in response to the IKEv2 SA-INIT message 800, ePDG 300 returns an IKEv2 SA_INIT_RSP message 805 that identifies a cryptographic algorithm for securing the connection between UE 105 and may include other data such as, for example, a random value used for key generation. Upon receipt of the IKEv2 SA_INIT_RSP message 805 from ePDG 300, UE 105 may send an IKEv2 AUTH_REQ message 810 to ePDG 300. The message 810 may include information about the PLMN and/or NPN to which the subscriber/UE 105 subscribes and may further include the UE 105’s Subscription Concealed Identifier (SUCI). The SUCI includes the Subscription Permanent Identifier (SUPI) of the UE 105 concealed using a security algorithm, such as an encryption algorithm. A SUPI may be concealed at a UE 105, to generate the UE 105’s SUCI using the security algorithm, and subsequently used for identifying the UE 105 when interacting with the PLMN 120 or NPN 115. A NF (e.g., UDM 350) of the PLMN 120/NPN 115 may include functionality for de-concealing the UE 105’s SUCI to recover the original SUPI. The PLMN/NPN information included in the message 810 may, for example, indicate if the PLMN 120/NPN 115 is a 4G network, a 5G stand-alone (SA) network, or a hybrid 4G/5G network having a 4G network that incorporates 5G Non-Stand Alone (NSA) components.

ePDG 300, based on the content of the IKE message(s), determines PLMN/NPN information of the subscriber associated with the UE 105 (block 705) and determines whether the UE 105/subscriber is a 4G subscriber, a 5G SA subscriber, or a 4G with 5G NSA subscriber (block 710). ePDG 300 extracts the PLMN/NPN information from the IKEv2 AUTH_REQ message 810 and identifies if the PLMN/NPN information indicates that the UE 105/subscriber is a 4G network subscriber, a 5G SA subscriber, or a 4G with 5G NSA subscriber. FIG. 8A depicts ePDG 300 determining 815 the UE 105/subscriber’s PLMN information based on contents of the message 810.

Returning to FIG. 7, if it is determined that the UE subscriber is a 5G SA subscriber, ePDG 300 triggers Extensible Authentication Protocol (EAP) authentication with the AUSF 320 of the 5G PLMN 120 (block 715). If, however, it is determined that the UE subscriber is either a 4G or a 4G w/5G NSA subscriber, then ePDG 300 triggers EAP authentication with the AAA server 320 of the 4G PLMN 120 (block 725). As shown in FIG. 8A, ePDG 300 triggers EAP authentication with either AUSF 320 of the 5G PLMN 120, or with AAA server 320 of the 4G PLMN 120 by sending a Diameter EAP Request (DER) 820, that includes UE 105’s SUCI, to NSWOF 305. If UE 105 is located in NPN 115, then NSWOF 305 would be located in PLMN 120. If UE 105 is located in PLMN 120, the NSWOF 305 would be located in NPN 115.

In response, NSWOF 305 translates 825 the incoming message (e.g., DER 820) to a message format compatible with the SBI of the SBA of the PLMN 120 (if UE 105 is located in the NPN 115) or NPN 115 (if UE 105 is located in the PLMN 120). NSWOF 305 takes the contents of the translated message and sends a UE Authentication Request 830, to AUSF/AAA server 320, that includes the UE 105’s SUCI and an identifier (ID) of the NSWOF 305 (e.g., a network address). AUSF/AAA server 320, in turn, sends a UE Authentication Get Request 835 to UDM/HSS 350 that includes the UE 105’s SUCI and the NSWOF_ID. UDM/HSS 350, upon receipt of Get Request 835 performs a deconcealment operation on UE 105’s SUCI, using a subscription identifier de-concealing function, to obtain UE 105’s Subscription Permanent ID (SUPI). The deconcealed SUPI is then used in an existing EAP-Authentication Key Agreement prime (AKA’) authentication process 840 to authenticate the UE 105 and to provide a session encryption key for a data session involving UE 105.

ePDG 300 determines if the UE 105 has been authenticated successfully (block 730). If the UE 105 was not successfully authenticated (NO – block 730), then ePDG 300 blocks the UE 105 from network access via ePDG 300 (block 740). If the UE 105 was successfully authenticated (YES- block 730), then ePDG 300 acknowledges the UE’s authentication and initiates creation of a secure tunnel with the UE 105 for Packet Data Unit (PDU) session establishment (block 735). If UE 105 is successfully authenticated, the known EAP-AKA’ authentication process 840 concludes with AUSF/AAA server 320 sending, to NSWOF 305, a UE Authentication Response message 845 (FIG. 8B) that includes a master session key (MSK) consisting of key material for use in establishing a secure tunnel between UE 105 and ePDG 300. NSWOF 305 translates 850 the incoming message 845 received from AUSF/AAA server 320 via the SBI 360 from the SBI-compatible message format to a first, different message format usable by ePDG 300. Upon receipt of the UE Authentication response 845, NSWOF 305 sends a Diameter EAP Answer (DEA) message 860, in the first message format, to ePDG 300, along with the MSK. ePDG 300, in turn, sends an IKEv2 AUTH_RESP message 865 to UE 105, with the MSK, to acknowledge the UE 105’s successful authentication and to initiate creation of a secure tunnel between UE 105 and ePDG 300. UE 105 may subsequently engage in a PDU session via the established secure tunnel and ePDG 300. FIG. 8B depicts a Secure Tunnel 870 established between UE 105 and ePDG 300 using the MSK obtained at the conclusion of the EAP-AKA’ authentication process 840. FIG. 8B further shows the PDU session 875, established over the secure tunnel 870, from UE 105 through SMF 310/UPF 315 and on to an endpoint (not shown) of the PDU session. The endpoint may include, for example, a data server (e.g., a Content Delivery Network (CDN) server) connected to data network 125. The PDU session involving UE 105 may subsequently be ended, as shown in FIG. 8B, with a Delete Session Request 880 sent from ePDG 300 to SMF 310/UPF 315 and a responsive Delete Session Response 885 being returned to ePDG 300 from SMF 310/UPF 315. The blocks of the example process of FIG. 7 may be repeated for each authentication of a UE 105 for establishing a secure tunnel between the UE 105 and ePDG 300.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks has been described with respect to FIG. 7, and a sequence of operations, messages, and/or data flows with respect to FIGS. 8A and 8B, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 620) of a device. A non-transitory storage medium includes one or more of the storage mediums described in relation to memory 630. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article "a" is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system within a Public Land Mobile Network (PLMN), comprising:
an Evolved Packet Data Gateway (ePDG) configured to receive control plane (CP) and user plane (UP) traffic sent from a User Equipment device (UE) over a Non-Public Network (NPN); and
a Non-Seamless Wireless Local Area Network (WLAN) Offload Function (NSWOF) configured to:
receive the CP traffic from the ePDG,
translate the CP traffic to a Service-Based Interface (SBI) format of a Service-Based Architecture (SBA) of the PLMN, and
send the translated CP traffic to at least one Network Function (NF) in the PLMN for accessing a PLMN service provided by the at least one NF.

2. The system of claim 1, wherein the ePDG is further configured to:
forward the UP traffic sent from the UE over the NPN towards a destination in a data network connected to the PLMN.

3. The system of claim 1, wherein the NSWOF is further configured to:
receive, from the at least one NF, responsive CP traffic associated with the PLMN service,
translate the responsive CP traffic to a first message format, and
send the translated, responsive CP traffic to the ePDG; and
wherein the ePDG is further configured to:
forward the translated, responsive CP traffic to the NPN.

4. The system of claim 3, wherein the translated, responsive CP traffic includes an encryption key for a data session to be sent from the UE to the ePDG via the NPN.

5. The system of claim 1, wherein the ePDG is further configured to:
establish a secure tunnel between the ePDG and the UE across the NPN.

6. The system of claim 1, wherein the PLMN comprises a Fourth Generation (4G) network and the at least one NF in the PLMN comprises an Authentication, Authorization, and Accounting (AAA server).

7. The system of claim 1, wherein the PLMN comprises a Fifth Generation (5G) network and the at least one NF in the PLMN comprises an Authentication Server Function (AUSF).

8. The system of claim 1, wherein the ePDG is further configured to:
establish a secure tunnel between the ePDG and the UE across the NPN,
receive the UP traffic sent from the UE via the NPN over the secure tunnel, and
forward the UP traffic to a User Plane Function (UPF) or a Packet Gateway (PGW) of the PLMN.

9. A method, comprising:
receiving, by one or more processors in a Public Land Mobile Network (PLMN), control plane (CP) and user plane (UP) traffic sent from a User Equipment device (UE) over a Non-Public Network (NPN);
translating, by the one or more processors, the CP traffic to a Service-Based Interface (SBI) format of a Service-Based Architecture (SBA) of the PLMN,
sending, by the one or more processors, the translated CP traffic to at least one Network Function (NF) in the PLMN for accessing a PLMN service provided by the at least one NF;
receiving, by the one or more processors, responsive CP traffic associated with the PLMN service provided by the at least one NF;
translating, by the one or more processors, the responsive CP traffic to a first message format; and
forwarding, by the one or more processors, the translated, responsive CP traffic to the NPN.

10. The method of claim 9, further comprising:
forwarding, by the one or more processors, the UP traffic sent from the UE over the NPN towards a destination in a data network connected to the PLMN.

11. The method of claim 9, wherein the one or more processors are components of an Evolved Packet Data Gateway (ePDG) and a Non-Seamless Wireless Local Area Network (WLAN) Offload Function (NSWOF).

12. The method of claim 11, wherein the ePDG performs the receiving of the CP and UP traffic and the forwarding of the translated, responsive CP traffic to the NPN, and
wherein the NSWOF performs the translating of the CP traffic to the SBI format, the sending of the translated CP traffic to the at least one NF, the receiving of the responsive CP traffic, and the translating of the responsive CP traffic to the first message format.

13. The method of claim 9, wherein the translated, responsive CP traffic includes an encryption key for a data session to be sent from the UE to the PLMN via the NPN.

14. The method of claim 9, wherein at least one of the one or more processors is a component of an Evolved Packet Data Gateway (ePDG) and further comprising:
establishing, by the ePDG, a secure tunnel between the ePDG and the UE across the NPN.

15. The method of claim 9, wherein the PLMN comprises a Fourth Generation (4G) network and the at least one NF in the PLMN comprises an Authentication, Authorization, and Accounting (AAA) server.

16. The method of claim 9, wherein the PLMN comprises a Fifth Generation (5G) network and the at least one NF in the PLMN comprises an Authentication Server Function (AUSF).

17. The method of claim 9, wherein at least one of the one or more processors is a component of an Evolved Packet Data Gateway (ePDG) and further comprising:
establishing, by the ePDG, a secure tunnel between the ePDG and the UE across the NPN;
receiving, by the ePDG, the UP traffic sent from the UE via the NPN over the secure tunnel; and
forwarding the UP traffic to a User Plane Function (UPF) or Packet Gateway (PGW) of the PLMN.

18. At least one non-transitory storage medium storing instructions executable by one or more network devices in a Public Land Mobile Network (PLMN), wherein execution of the instructions causes the one or more network devices to:
receive control plane (CP) and user plane (UP) traffic sent from a User Equipment device (UE) over a Non-Public Network (NPN);
translate the CP traffic to a Service-Based Interface (SBI) format of a Service-Based Architecture (SBA) of the PLMN,
send the translated CP traffic to at least one Network Function (NF) in the PLMN for accessing a PLMN service provided by the at least one NF;
receive responsive CP traffic associated with the PLMN service provided by the at least one NF;
translate the responsive CP traffic to a first message format; and
forward the translated, responsive CP traffic to the NPN.

19. The non-transitory storage medium of claim 18, wherein execution of the instructions further causes the one or more network devices to:
receive, from the at least one NF, responsive CP traffic associated with the PLMN service;
translate the responsive CP traffic to a first message format; and
forward the translated, responsive CP traffic to the NPN.

20. The non-transitory storage medium of claim 18, wherein execution of the instructions further causes the one or more network devices to:
establish a secure tunnel with the UE across the NPN,
receive the UP traffic sent from the UE via the NPN over the secure tunnel, and
forward the UP traffic to a User Plane Function (UPF) or a Packet Gateway (PGW) of the PLMN.
